(19) United States
(12) Patent Application Publication
(10) Pub. No.: US 2026/0180246 A1
(43) Pub. Date: Jun. 25, 2026

(54) CONNECTOR

(71) Applicant: SUMITOMO WIRING SYSTEMS, LTD., Mie (JP)

(72) Inventors: Harutaka INOUE, Mie (JP); Kazuo NAKAI, Mie (JP)

(21) Appl. No.: 19/421,721

(22) Filed: Dec. 16, 2025

(30) Foreign Application Priority Data
Dec. 19, 2024 (JP) 2024-224134

(51) Int. Cl. H01R 13/629; H01R 13/514; H01R 13/627

(52) U.S. Cl. CPC H01R 13/62938; H01R 13/514; H01R 13/6278; H01R 13/62977

(57) ABSTRACT

A connector includes: an arcuate rotation mechanism that rotates a lever along an arcuate locus; and a conversion mechanism that converts an operating direction of the lever along an arc to a fitting direction in which a lever connector is fitted to a mating connector in conjunction with movement of the lever rotated along the arc by the arcuate rotation mechanism. The arcuate rotation mechanism includes: a hook-shaped lever inner circumferential portion formed at the tip of the lever; an inner sliding portion that is formed in a connector housing and is in sliding contact with the lever inner circumferential portion; a lever outer circumferential portion formed on a surface of the lever opposite to the lever inner circumferential portion; and an outer sliding portion that is formed in the connector housing and is in sliding contact with the lever outer circumferential portion.

### CROSS-REFERENCE TO RELATED APPLICATIONS

This application is based on and claims priority from Japanese Patent Application No. 2024-224134, filed on December 19, 2024, with the Japan Patent Office, the disclosure of which is incorporated herein in its entirety by reference.

### TECHNICAL FIELD

The present disclosure relates to a connector.

### BACKGROUND

Conventionally, a lever-type connector is known in which a first connector housing and a second connector housing are fitted together by rotating a fitting operation lever rotatably attached to first lever engagement shaft portions formed on a pair of outer walls of the first connector housing as disclosed in JP 2014-002864 A. In JP 2014-002864 A, when the fitting operation lever is operated from a fitting start position to a fitting end position, second lever engagement shaft portions of the second connector housing slide in cam grooves of the first connector housing, so that the connector housings are fitted together by a force acting from the cam grooves in the fitting direction. JP 2014-002864 A is an example of related art.

### SUMMARY

In JP 2014-002864 A, the lever is of a rotary operation type, and therefore, the lever requires rotation shafts, more specifically, the lever requires first lever rotation shaft portions. Therefore, it is necessary to provide a space for disposing such rotation shafts in the connector, and this has been an obstacle to downsizing the connector.

An object of the present disclosure is to provide a connector that enables downsizing of a lever connector.

A connector that solves the above problem is configured such that a connector housing of a lever connector is drawn into a mating connector and fitted to the mating connector in a process of operating a lever from an initial position to a fitting position, the lever being provided in an operable manner on the lever connector configured to be connected to the mating connector, the connector including: an arcuate rotation mechanism that rotates the lever along an arcuate locus between the initial position and the fitting position; and a conversion mechanism that converts an operating direction of the lever along an arc to a fitting direction in which the lever connector is fitted to the mating connector in conjunction with movement of the lever rotated along the arc by the arcuate rotation mechanism, wherein the arcuate rotation mechanism includes: a hook-shaped lever inner circumferential portion formed at a tip of the lever; an inner sliding portion that is formed in the connector housing and is in sliding contact with the lever inner circumferential portion; a lever outer circumferential portion formed on a surface of the lever opposite to the lever inner circumferential portion; and an outer sliding portion that is formed in the connector housing and is in sliding contact with the lever outer circumferential portion.

According to the present disclosure, the lever connector can be downsized.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a fitted state of a connector.

FIG. 2 is a perspective view showing a state before a lever connector is fitted to a mating connector.

FIG. 3 is a perspective view of the lever connector.

FIG. 4 is a back view of the lever connector as viewed from the direction of a terminal insertion surface.

FIG. 5 is an exploded perspective view of the lever connector as viewed obliquely from above.

FIG. 6 is an exploded perspective view of the lever connector as viewed obliquely from below.

FIG. 7 is a cross-sectional view showing a state in which the lever connector in which a lever is located at an initial position is fitted to the mating connector.

FIG. 8 is a partially cutaway perspective view showing an inner structure of an upper portion of a connector housing.

FIG. 9 is a partially cutaway perspective view showing an inner structure of a lower portion of the connector housing.

FIG. 10 is a perspective view showing the shapes of the mating connector and the lever.

FIG. 11A is a cross-sectional view of the connector when a fitting direction rotation restricting mechanism is released, and FIG. 11B is a cross-sectional view of the connector in which the lever has been operated by a predetermined amount after the fitting direction rotation restricting mechanism is released.

FIG. 12A is a cross-sectional view showing a state in which the lever connector is to be inserted into the mating connector, and FIG. 12B is a cross-sectional view showing a state in which the lever connector is being inserted into the mating connector.

FIG. 13 is a cross-sectional view of the connector when the lever is operated to the vicinity of an intermediate position.

FIG. 14 is a cross-sectional view of the connector when the lever is operated to the vicinity of a movement end position.

FIG. 15 is a cross-sectional view of the connector when the lever connector is fitted to the mating connector.

FIG. 16A is an explanatory diagram showing an outermost circumferential locus, which is the locus of an operating portion of a lever in the case where the lever is of a simple rotary operation type, and FIG. 16B is an explanatory diagram showing an outermost circumferential locus, which is the locus of an operating portion of a lever in the case where the lever is configured to rotate along an arc.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

First, embodiments of the present disclosure are listed and described.

[1] A connector according to the present disclosure is configured such that a connector housing of a lever connector is drawn into a mating connector and fitted to the mating connector in a process of operating a lever from an initial position to a fitting position, the lever being provided in an operable manner on the lever connector configured to be connected to the mating connector, the connector including: an arcuate rotation mechanism that rotates the lever along an arcuate locus between the initial position and the fitting position; and a conversion mechanism that converts an operating direction of the lever along an arc to a fitting direction in which the lever connector is fitted to the mating connector in conjunction with movement of the lever rotated along the arc by the arcuate rotation mechanism, wherein the arcuate rotation mechanism includes: a hook-shaped lever inner circumferential portion formed at a tip of the lever; an inner sliding portion that is formed in the connector housing and is in sliding contact with the lever inner circumferential portion; a lever outer circumferential portion formed on a surface of the lever opposite to the lever inner circumferential portion; and an outer sliding portion that is formed in the connector housing and is in sliding contact with the lever outer circumferential portion.

With this configuration, when the lever is operated from the initial position to the fitting position, the operating direction of the lever is converted to the fitting direction of the lever connector by the conversion mechanism, and thus the lever connector is fitted to the mating connector. At this time, the lever is rotated by the arcuate rotation mechanism so as to follow an arcuate locus. As described above, in this configuration, the movement structure of the lever is a rotary structure in which the lever is operated to slide. Therefore, when compared with a case where the lever is of a simple rotary operation type, for example, there is no need to provide a rotation shaft for the lever, so that the space required for disposing parts can be reduced. Therefore, the connector can be downsized.

[2] In the connector described above in [1], the connector housing has a terminal insertion surface that has a terminal insertion hole into which a terminal is inserted, and the inner sliding portion is disposed on the same plane as the terminal insertion surface. With this configuration, an imaginary center of the arcuate rotation locus of the lever can be set apart from the terminal insertion surface in the direction opposite to the fitting direction of the lever connector. Accordingly, the outermost circumferential locus of the lever when the lever is rotated from the initial position to the fitting position can be set far from the connector housing. Therefore, the terminal insertion surface is hardly hidden by an operating portion of the lever, and this facilitates insertion of the terminal into the terminal insertion hole.

[3] In the connector described above in [1] or [2], wherein, when a direction along a longitudinal direction of a recess in the connector housing into which an arm portion of the lever is inserted is defined as a prescribed direction, the inner sliding portion is disposed at an end portion of the connector housing in the prescribed direction or in a vicinity of the end portion. According to this configuration, the inner sliding portion is disposed at the end portion of the connector housing in the prescribed direction or in the vicinity of the end portion, and therefore, the arm portion of the lever can be made long. Therefore, a sufficient power assist effect of the lever can be obtained. As a result, the operation load of the lever can be reduced, thereby improving the efficiency of the fitting operation.

[4] In the connector described above in any of [1] to [3], the inner sliding portion is in the form of a column with which the lever inner circumferential portion of the lever is engaged in a slidable manner, and both ends of the column are connected to the connector housing. In this configuration, the opposite ends of the columnar inner sliding portion are supported by the connector housing, and therefore, the strength of the inner sliding portion can be increased.

[5] In the connector described above in any of [1] to [4], the conversion mechanism is a cam mechanism that converts the operating direction of the lever along an arc to the fitting direction in which the lever connector is fitted to the mating connector by an action of a cam structure including a cam pin formed in the mating connector and a cam groove formed in the lever to be engaged with the cam pin, and the connector includes a plurality of pairs of the cam pin and the cam groove.

With this configuration, when the lever connector is fitted to the mating connector by operating the lever, the lever connector can be supported by the plurality of cam pins in a well-balanced manner with respect to the mating connector. Therefore, when the lever connector is fitted to the mating connector, it is possible to suppress tilting of the connector housing and to smoothly fit the lever connector to the mating connector.

[6] In the connector described above in [3], the conversion mechanism is a cam mechanism that converts the operating direction of the lever along an arc to the fitting direction in which the lever connector is fitted to the mating connector by an action of a cam structure including a cam pin formed in the mating connector and a cam groove formed in the lever to be engaged with the cam pin, and, when a line passing through the inner sliding portion in the fitting direction of the lever connector and the mating connector is defined as a reference line, the cam pin is disposed on a side opposite to the end portion with respect to the reference line. If the inner sliding portion is disposed at or in the vicinity of the end portion of the connector housing in the prescribed direction, the space for disposing the cam mechanism may be limited. However, in this configuration, the cam pin is disposed in a space in which parts can be disposed. Therefore, it is possible to dispose the inner sliding portion at or in the vicinity of the end portion of the connector housing in the prescribed direction and to secure the space for disposing the cam mechanism at the same time.

### [Detailed Description of Embodiment of the Present Disclosure]

Specific examples of the present disclosure will be described below with reference to the drawings. Note that the present disclosure is not limited to these examples, but is indicated by the claims, and is intended to encompass all modifications within the meaning and scope equivalent to the claims. In the drawings, part of a configuration may be exaggerated or simplified for convenience of description. Also, proportions of the dimensions of respective portions shown in the drawings may be different from the actual proportions.

### Connector 1

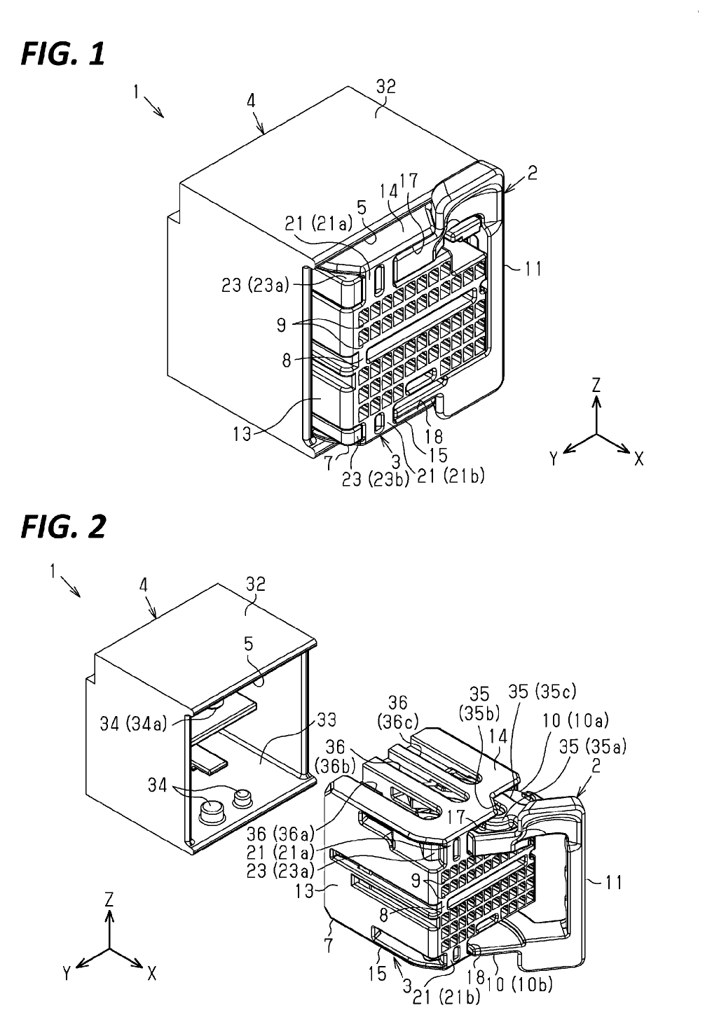

As shown in FIGS. 1 and 2, a connector 1 includes a lever connector 3 including a lever 2 that is operated when fitting, and a mating connector 4 to which the lever connector 3 is fitted. The mating connector 4 includes an accommodating portion 5 that accommodates the lever connector 3 when the lever connector 3 is fitted to the mating connector 4. The lever connector 3 is accommodated in the accommodating portion 5 such that a predetermined surface of the lever connector 3 is exposed from the accommodating portion 5. One of the lever connector 3 and the mating connector 4 is a male connector, and the other is a female connector.

### Lever Connector 3

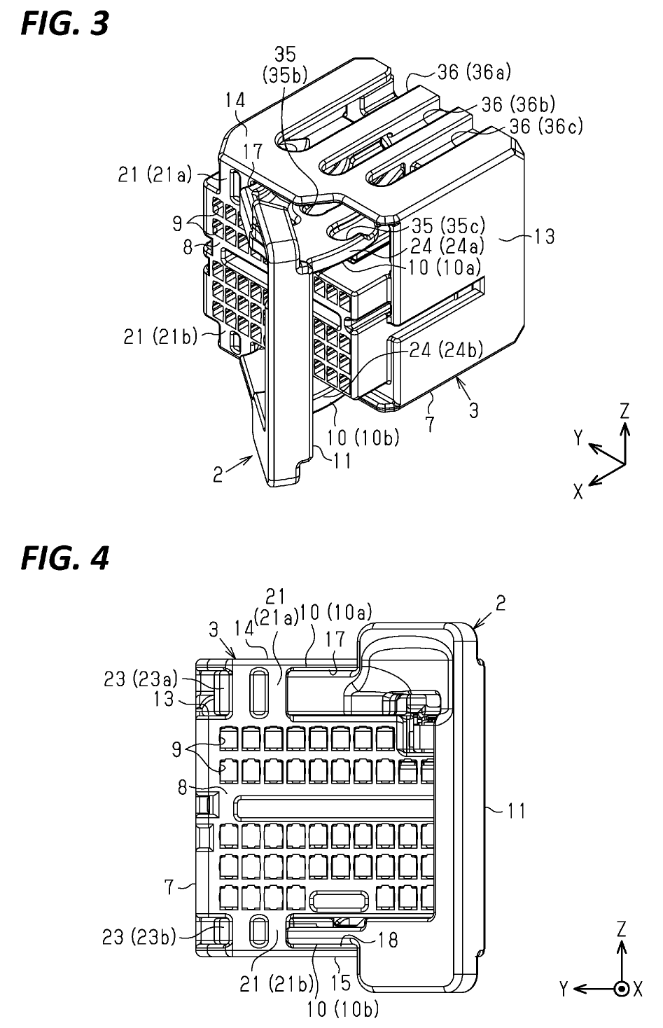

As shown in FIGS. 1 to 4, the lever connector 3 includes a connector housing 7 to which a plurality of terminals (not shown) are attached. The connector housing 7 has a substantially block shape corresponding to the shape of the accommodating portion 5, for example. The connector housing 7 has a terminal insertion surface 8, which is exposed when the lever connector 3 is fitted to the mating connector 4, and the terminal insertion surface 8 has a plurality of terminal insertion holes 9 for inserting terminals. The lever 2 is attached to the connector housing 7 in such a manner as to be movable relative to the connector housing 7.

The lever 2 is operated between an initial position (the state shown in FIGS. 2 to 4) at which the lever 2 is located before a fitting operation and a fitting position (the state shown in FIG. 1) at which the lever 2 is located when the operation for fitting the lever connector 3 and the mating connector 4 is complete. When the lever connector 3 is fitted to the mating connector 4 and the lever 2 is operated from the initial position to the fitting position, the lever connector 3 enters the mating connector 4 due to an operating load of the lever 2, and the lever connector 3 is completely fitted to the mating connector 4.

### Lever 2

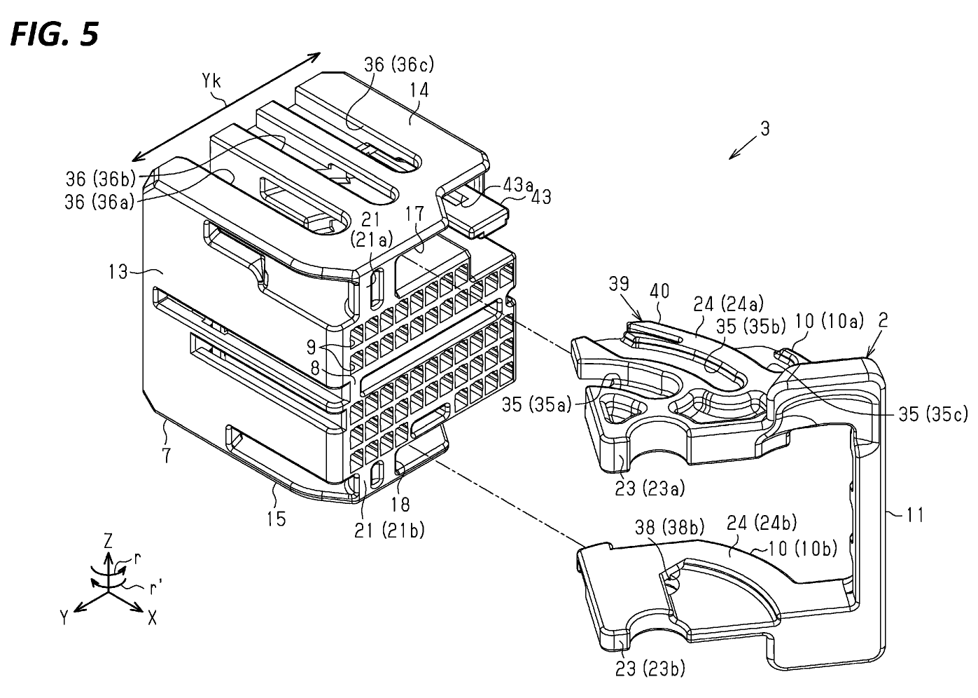

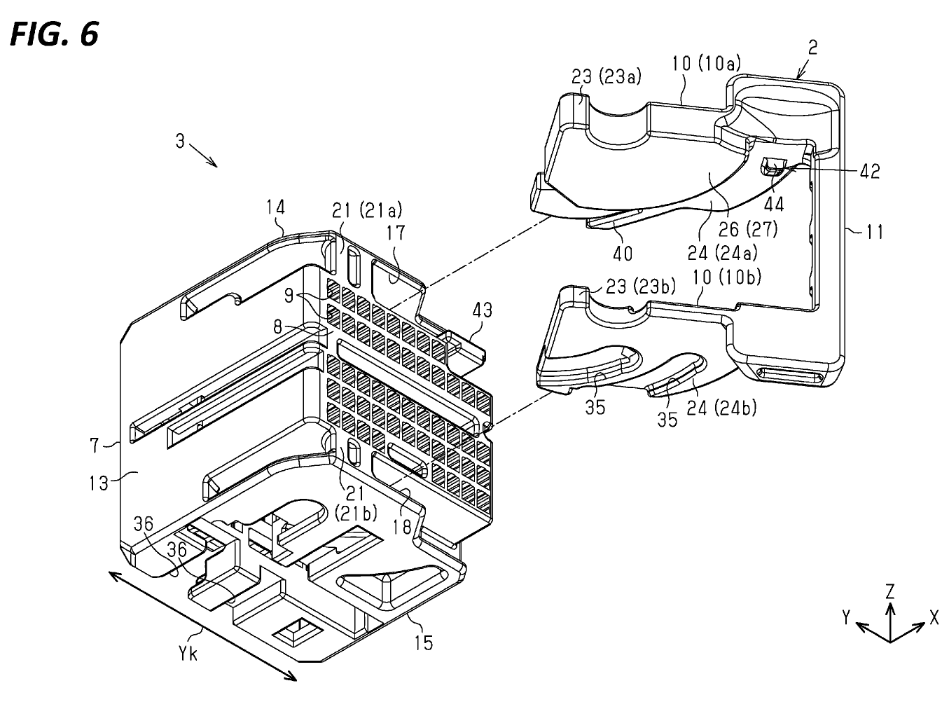

As shown in FIGS. 5 and 6, the lever 2 includes a pair of arm portions 10 and an operating portion 11 connecting the pair of arm portions 10 and configured to be held when the lever 2 is operated. Thus, the lever 2 is formed into a double-supported shape including the arm portions 10 extending from both sides of the operating portion 11. In this example, the pair of arm portions 10 include a first arm portion 10a and a second arm portion 10b facing each other.

### Connector Housing 7

The connector housing 7 includes a main body 13 in which the terminal insertion holes 9 are formed, a first outer wall 14 facing the main body 13, and a second outer wall 15 located on the side opposite to the first outer wall 14. The first arm portion 10a is inserted in a slidable manner into a first recess 17 formed between the main body 13 and the first outer wall 14. The second arm portion 10b is inserted in a slidable manner into a second recess 18 formed between the main body 13 and the second outer wall 15.

### Arcuate Rotation Mechanism 20

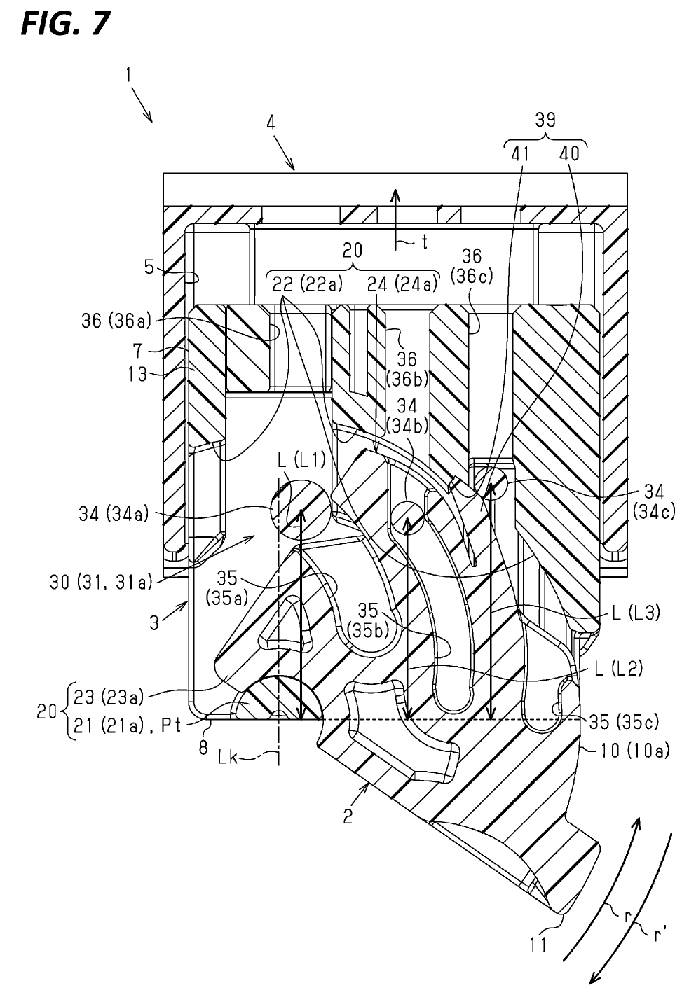

As shown in FIG. 7, the lever connector 3 includes an arcuate rotation mechanism 20 for rotating the lever 2 between the initial position and the fitting position along an arcuate locus. The arcuate rotation mechanism 20 moves the lever 2 to the initial position or the fitting position by, for example, rotating the lever 2 along an arcuate locus with the arm portions 10 of the lever 2 sliding within the connector housing 7.

### Inner Sliding Portion 21 and Outer Sliding Portion 22

As shown in FIG. 7, the arcuate rotation mechanism 20 includes an inner sliding portion 21 and an outer sliding portion 22 that are formed in the connector housing 7. The inner sliding portion 21 is formed so as to have a curved surface that comes into contact with the lever 2. In this example, the inner sliding portion 21 has a semicircular cross section, for example. The inner sliding portion 21 is disposed on the inner side of the arcuate rotation locus of the lever 2. The inner sliding portion 21 is engaged with an inner circumferential surface of a lever tip, which is the innermost circumferential surface in the radial direction of the lever 2 rotating along an arc.

As shown in FIGS. 5 and 6, the inner sliding portion 21 includes a first inner sliding portion 21a with which the tip of the first arm portion 10a engages, and a second inner sliding portion 21b with which the tip of the second arm portion 10b engages. The first inner sliding portion 21a extends between the main body 13 and the first outer wall 14 of the connector housing 7. Thus, both ends of the first inner sliding portion 21a are connected to the connector housing 7. The second inner sliding portion 21b extends between the main body 13 and the second outer wall 15 of the connector housing 7. Thus, both ends of the second inner sliding portion 21b are connected to the connector housing 7. Accordingly, the inner sliding portion 21 of this example is in the form of a column and opposite ends of the column (more specifically, upper and lower ends of the column) are connected to the connector housing 7.

The inner sliding portion 21 is disposed on the same plane as the terminal insertion surface 8 of the connector housing 7. The inner sliding portion 21 is disposed at an end portion (the left end in the drawings) of the terminal insertion surface 8 of the connector housing 7. In this example, the inner sliding portion 21 is located at a corner of the terminal insertion surface 8, which is substantially rectangular as viewed from the back. Thus, the inner sliding portion 21 is disposed at an end portion of the connector housing 7 in a prescribed direction Yk (the Y-axis direction in FIG. 5, etc.: the width direction in the drawings) or in the vicinity of the end portion. The prescribed direction Yk is a direction along the longitudinal direction (the left-right direction in the drawings) of the first recess 17 (or the second recess 18) of the connector housing 7 into which an arm portion 10 of the lever 2 is inserted.

As shown in FIGS. 7 to 9, the outer sliding portion 22 is formed so as to have a curved surface that comes into contact with the lever 2. In this example, the outer sliding portion 22 has, for example, a semicircular shape having a larger radius than the radius of a circle formed by a circumferential surface of the inner sliding portion 21. As shown in FIG. 7, the outer sliding portion 22 is located on the outer side of the arcuate rotation locus of the lever 2. The outer sliding portion 22 is engaged with an outer circumferential surface of the lever 2, which is the outermost circumferential surface in the radial direction of the lever 2 rotating along an arc.

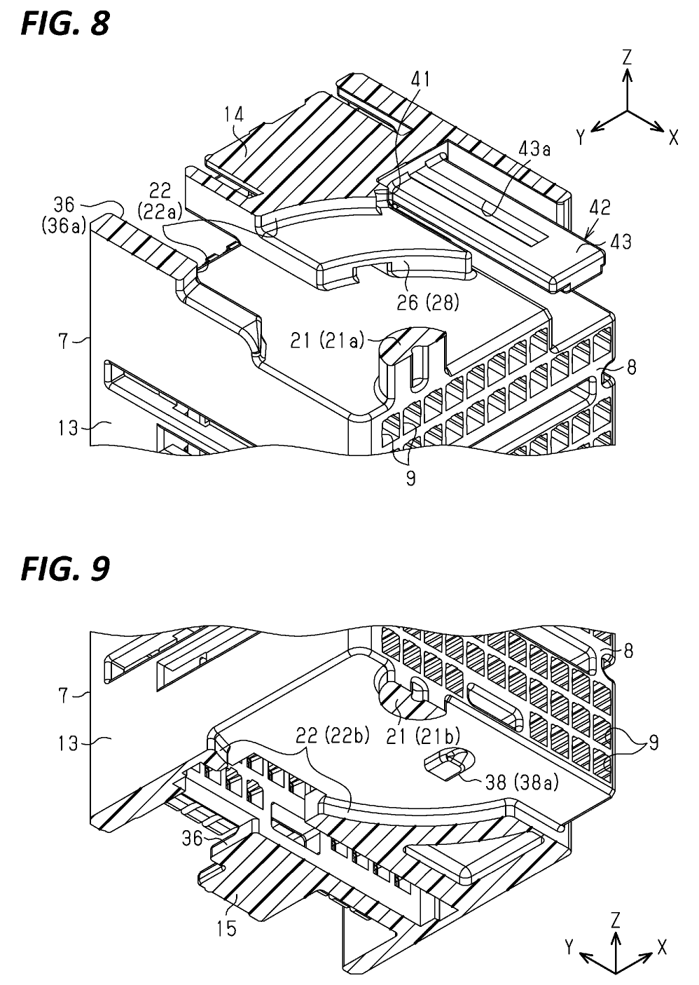

As shown in FIGS. 8 and 9, the outer sliding portion 22 includes a first outer sliding portion 22a (see FIG. 8) with which an outer circumferential surface of the first arm portion 10a comes into contact, and a second outer sliding portion 22b (see FIG. 9) with which an outer circumferential surface of the second arm portion 10b comes into contact. The first outer sliding portion 22a is a wall located in the first recess 17 of the connector housing 7. The second outer sliding portion 22b is a wall located in the second recess 18 of the connector housing 7.

### Lever Inner Circumferential Portion 23 and Lever Outer Circumferential Portion 24

As shown in FIGS. 5 to 7, the arcuate rotation mechanism 20 includes a lever inner circumferential portion 23 and a lever outer circumferential portion 24 that are formed in the lever 2. The lever inner circumferential portion 23 is engaged with the inner sliding portion 21 of the connector housing 7 in a slidable manner. The lever inner circumferential portion 23 is included in the inner circumferential surface of the tip of the arm portion 10 and has a hook shape. The lever 2 is attached to the connector housing 7 by engaging the hook-shaped lever inner circumferential portion 23 with the inner sliding portion 21. The engaging surface of the lever inner circumferential portion 23 is formed into a substantially arc shape to match the shape of the inner sliding portion 21. In this example, the lever inner circumferential portion 23 is a bearing for the inner sliding portion 21.

As shown in FIGS. 5 and 6, the lever inner circumferential portion 23 includes a first lever inner circumferential portion 23a formed at the tip of the first arm portion 10a of the lever 2, and a second lever inner circumferential portion 23b formed at the tip of the second arm portion 10b of the lever 2. The first lever inner circumferential portion 23a comes into sliding contact with the first inner sliding portion 21a of the connector housing 7. The second lever inner circumferential portion 23b comes into sliding contact with the second inner sliding portion 21b of the connector housing 7.

As shown in FIGS. 5 to 7, the lever outer circumferential portion 24 is formed on a surface of the arm portion 10 on the side opposite to the lever inner circumferential portion 23 in a plane direction. The lever outer circumferential portion 24 is formed to be capable of coming into slidable contact with the outer sliding portion 22 of the connector housing 7 when disposed so as to face the outer sliding portion 22. The lever outer circumferential portion 24 is formed into a substantially arc shape to match the shape of the outer sliding portion 22.

As shown in FIGS. 5 and 6, the lever outer circumferential portion 24 includes a first lever outer circumferential portion 24a formed on the outer circumferential surface of the first arm portion 10a of the lever 2, and a second lever outer circumferential portion 24b formed on the outer circumferential surface of the second arm portion 10b of the lever 2. The first lever outer circumferential portion 24a is formed to be slidable along the first outer sliding portion 22a of the connector housing 7. The second lever outer circumferential portion 24b is formed to be slidable along the second outer sliding portion 22b of the connector housing 7.

As shown in FIG. 7, when the lever 2 is operated from the initial position to the fitting position, the lever inner circumferential portion 23 slides along the arc shape of the inner sliding portion 21, and the lever outer circumferential portion 24 slides along the arc shape of the outer sliding portion 22, so that the lever 2 rotates in an arc direction (the direction of an arrow r in FIG. 7). In this way, the lever 2 is operated to the initial position and the fitting position by rotating along an arc between the inner sliding portion 21 and the outer sliding portion 22. When the lever 2 is operated to rotate along an arc, the lever 2 rotates along the arc with respect to a fulcrum Pt that is located at the tip of the lever 2. In this example, the fulcrum Pt is the inner sliding portion 21 with which the tip of the lever 2 comes into sliding contact.

### Guide Mechanism 26

As shown in FIGS. 6 and 8, the lever connector 3 includes a guide mechanism 26 for guiding the arcuate rotation of the lever 2. The guide mechanism 26 includes, for example, a guide portion 27 (see FIG. 6) formed in the lever 2 and a guide surface 28 (see FIG. 8) formed in the connector housing 7. The guide portion 27 is formed on the underside of the first arm portion 10a in such a manner as to abut against the guide surface 28, for example. The guide surface 28 stands upright from the upper surface of the main body 13 of the connector housing 7, for example. The guide portion 27 and the guide surface 28 have arc shapes corresponding to the direction of the arcuate rotation of the lever 2. When the lever 2 is operated, the guide mechanism 26 guides the arcuate rotation of the lever 2 by moving a side surface of the guide portion 27 along the guide surface 28.

### Conversion Mechanism 30

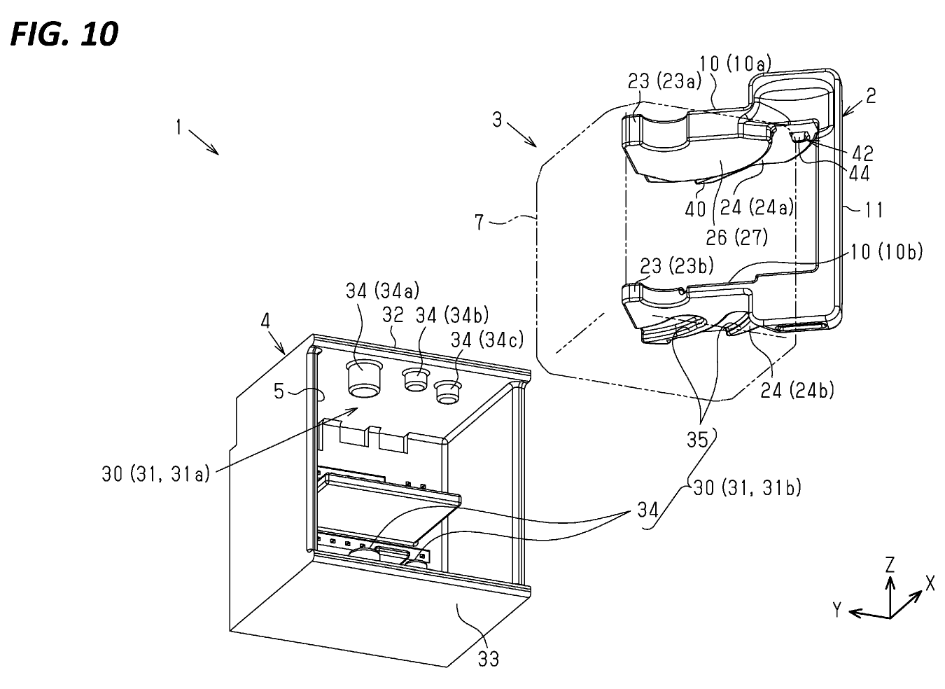

As shown in FIGS. 7 and 10, the connector 1 includes a conversion mechanism 30 that converts an operating direction of the lever 2 (the direction of the arrow r in FIG. 7) to a fitting direction (the direction of an arrow t in FIG. 7) in which the lever connector 3 is fitted to the mating connector 4. The conversion mechanism 30 converts the operating direction of the lever 2 along an arc to the fitting direction in which the lever connector 3 is fitted to the mating connector 4 in conjunction with the movement of the lever 2 rotated along the arc by the arcuate rotation mechanism 20.

The conversion mechanism 30 is a cam mechanism 31 that converts the operating direction of the lever 2 to the fitting direction of the lever connector 3 by the action of a cam structure. The cam mechanism 31 includes a first cam mechanism 31a (see FIG. 7) formed between the first arm portion 10a of the lever 2 and a first wall portion 32 of the mating connector 4, and a second cam mechanism 31b (see FIG. 10) formed between the second arm portion 10b of the lever 2 and a second wall portion 33 of the mating connector 4 facing the first wall portion 32.

As shown in FIG. 7, the first cam mechanism 31a includes a plurality of cam pins 34 projecting from the inner surface of the first wall portion 32, and a plurality of cam grooves 35 formed in the outer surface of the first arm portion 10a of the lever 2 such that the cam pins 34 engage with the cam grooves. The plurality of cam pins 34 include a first cam pin 34a disposed so as to be the closest to the inner sliding portion 21 of the lever connector 3 to be fitted to the mating connector 4, a second cam pin 34b adjacent to the first cam pin 34a, and a third cam pin 34c adjacent to the second cam pin 34b. These cam pins 34 have circular cross sections. The diameter of the first cam pin 34a is larger than the diameters of the second cam pin 34b and the third cam pin 34c.

The first cam pin 34a, the second cam pin 34b, and the third cam pin 34c are formed at different distances L from an opening of the accommodating portion 5 of the mating connector 4, respectively. In this example, a relationship "L2<L1<L3" is set for the distance L1 from the opening of the accommodating portion 5 to the center of the first cam pin 34a, the distance L2 from the opening of the accommodating portion 5 to the center of the second cam pin 34b, and the distance L3 from the opening of the accommodating portion 5 to the center of the third cam pin 34c.

The first cam pin 34a (in this example, all of the first to third cam pins 34a to 34c) is disposed on the side (the right side in the drawing) opposite to the end portion where the inner sliding portion 21 is disposed, with respect to a reference line Lk that passes through the inner sliding portion 21 in the fitting direction of the lever connector 3 and the mating connector 4. As described above, in this example, the plurality of cam pins 34 are disposed at positions on the right side of the reference line Lk passing through the inner sliding portion 21 in the fitting direction in the drawing.

As shown in FIG. 10, in this example, a protruding amount of the first cam pin 34a from a ceiling surface is larger than protruding amounts of the second cam pin 34b and the third cam pin 34c. In this example, the diameter and length of the first cam pin 34a are larger than those of the second cam pin 34b and the third cam pin 34c. In the power assist structure of the cam mechanism 31, an operation load is taken out from the first cam pin 34a, which is the closest to the fulcrum Pt (see FIG. 7), and therefore, the first cam pin 34a is formed to have the largest diameter and the longest length, compared with the other pins.

As shown in FIGS. 5 and 7, the connector housing 7 has a plurality of slits 36 through which the cam pins 34 pass when the lever connector 3 and the mating connector 4 are fitted. The slits 36 include a first slit 36a through which the first cam pin 34a passes, a second slit 36b through which the second cam pin 34b passes, and a third slit 36c through which the third cam pin 34c passes. The slits 36 are formed linearly along the fitting direction (the X-axis direction in FIG. 5, etc.) of the lever connector 3 and the mating connector 4.

The plurality of cam grooves 35 include a first cam groove 35a disposed in the vicinity of the inner sliding portion 21 of the connector housing 7, a second cam groove 35b disposed at a position farther from the inner sliding portion 21 than the first cam groove 35a is, and a third cam groove 35c disposed at a position farther from the inner sliding portion 21 than the second cam groove 35b is. The first cam groove 35a is a groove with which the first cam pin 34a engages, and has a depth corresponding to the protruding amount of the first cam pin 34a. The second cam groove 35b is a groove with which the second cam pin 34b engages, and has a depth corresponding to the protruding amount of the second cam pin 34b. The third cam groove 35c is a groove with which the third cam pin 34c engages, and has a depth corresponding to the protruding amount of the third cam pin 34c.

The first, second, and third cam grooves 35a, 35b, and 35c are each formed as an arcuate path corresponding to the direction of the arcuate rotation of the lever 2. In this example, the first, second, and third cam grooves 35a, 35b, and 35c are formed such that the second cam groove 35b is the longest, the first cam groove 35a is the second longest, and the third cam groove 35c is the shortest. The length of the third cam groove 35c is set such that the third cam pin 34c enters the third cam groove 35c in the latter half of the operation of the lever 2 from the initial position to the fitting position.

Note that the second cam mechanism 31b is configured in the same manner as the first cam mechanism 31a except that the third cam pin 34c and the third cam groove 35c are not provided. Therefore, a description of the second cam mechanism 31b is omitted.

### Reverse Rotation Restricting Mechanism 38

As shown in FIGS. 5 and 9, the lever connector 3 includes a reverse rotation restricting mechanism 38 that prevents the lever 2 at the initial position from falling off the connector housing 7. The reverse rotation restricting mechanism 38 includes, for example, a protrusion 38a (see FIG. 9) formed in the connector housing 7 and an abutting wall 38b (see FIG. 5) formed in the lever 2 and configured to be engaged with the protrusion 38a. The protrusion 38a is formed on the underside of the main body 13 of the connector housing 7. The abutting wall 38b is formed in the inner surface of the second arm portion 10b of the lever 2.

Even if the lever 2 that is located at the initial position is further operated in the direction of opening (the direction of an arrow r′ in FIG. 5), the protrusion 38a abuts against the abutting wall 38b and restricts further reverse rotation of the lever 2. Thus, when the lever 2, which is supported by the connector housing 7 in such a manner as to be rotatable along an arc, is located at the initial position, the lever 2 is prevented from falling off the connector housing 7 by the abutment between the protrusion 38a and the abutting wall 38b.

### Fitting Direction Rotation Restricting Mechanism 39

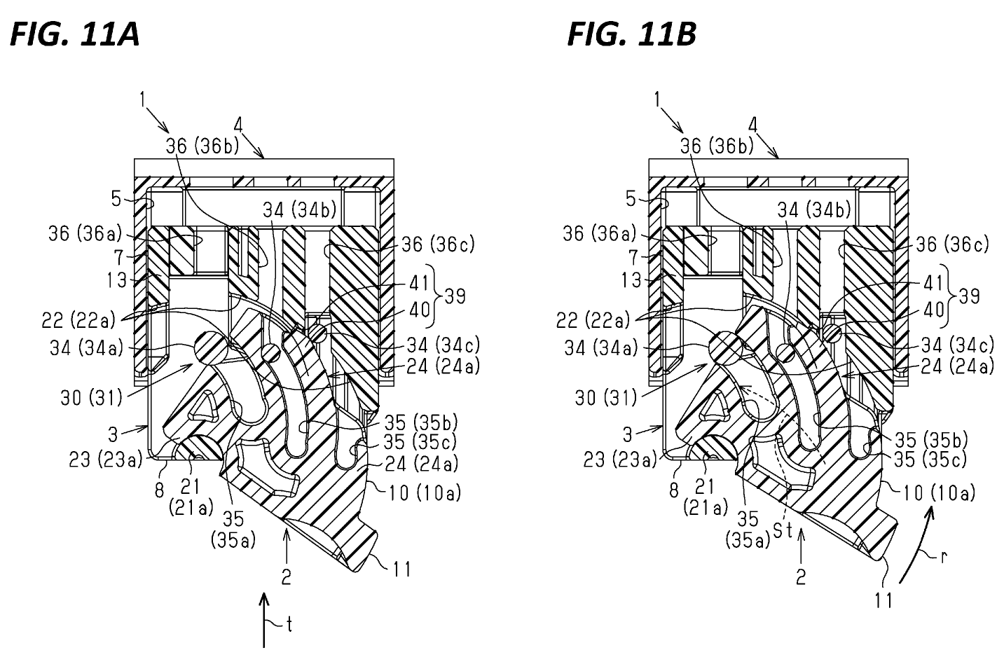

As shown in FIGS. 7, 11A, and 11B, the lever connector 3 includes a fitting direction rotation restricting mechanism 39 that restricts rotation in the fitting direction (in the direction of the arrow r in FIG. 7) at the initial position of the lever 2 before the lever connector 3 is fitted to the mating connector 4. The fitting direction rotation restricting mechanism 39 includes, for example, an elastic piece 40 formed in the lever 2 and a groove portion 41 formed in the connector housing 7 to be engaged with the elastic piece 40. The elastic piece 40 is disposed on a path along which the third cam pin 34c moves when the lever connector 3 is fitted to the mating connector 4. The elastic piece 40 is formed in the vicinity of the entrance of the third cam groove 35c of the lever 2. The elastic piece 40 is a part of the first lever outer circumferential portion 24a of the lever 2. The groove portion 41 is a part of the first outer sliding portion 22a of the connector housing 7.

As shown in FIG. 11A, when the lever connector 3 with the lever 2 located at the initial position is fitted to the mating connector 4 and further pushed into the fitting direction (the direction of an arrow t in FIG. 11A), the third cam pin 34c pushes the elastic piece 40 and elastically deforms the elastic piece. Thus, the elastic piece 40 is disengaged from the groove portion 41. Accordingly, as shown in FIG. 11B, the lever 2 located at the initial position is allowed to be operated to rotate along an arc in a direction toward the fitting position (the direction of an arrow St in FIG. 11B).

### Lock Mechanism 42

As shown in FIGS. 6 and 8, the lever connector 3 includes a lock mechanism 42 that locks the lever 2 at the fitting position. The lock mechanism 42 includes, for example, a lock arm 43 formed in the connector housing 7 (see FIG. 8) and a protrusion 44 formed on the lever 2 (see FIG. 6). The lock arm 43 is elastically deformable, and a surface of the lock arm 43 that faces the first arm portion 10a of the lever 2 has an arm groove 43a to be engaged with the protrusion 44. The protrusion 44 is formed, for example, on the underside of the first arm portion 10a of the lever 2. When the lever 2 is operated to the fitting position, the protrusion 44 engages with the arm groove 43a of the lock arm 43, and the lever 2 is kept at the fitting position.

### Actions of Embodiment

Next, the following describes actions of the connector 1 according to the present embodiment.

### Procedure of Fitting Lever Connector 3 to Mating Connector 4

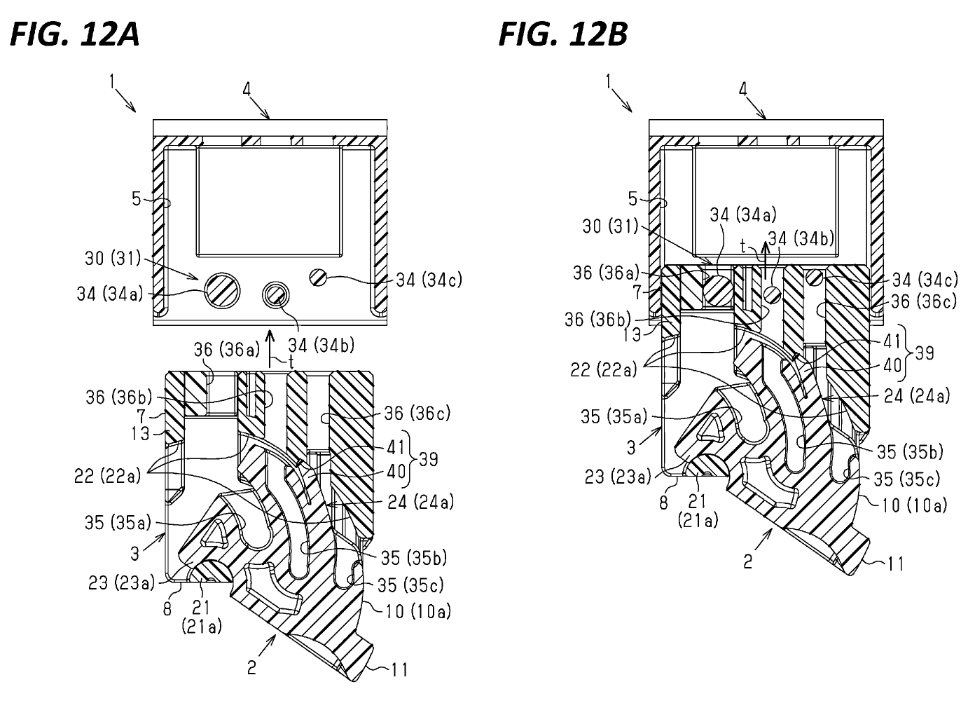

As shown in FIG. 12A, when the lever connector 3 is to be fitted to the mating connector 4, first, the lever connector 3 with the lever 2 located at the initial position is inserted into the accommodating portion 5 of the mating connector 4. As shown in FIG. 12B, during the process of fitting the lever connector 3 into the accommodating portion 5, the first cam pin 34a passes through the first slit 36a, the second cam pin 34b passes through the second slit 36b, and the third cam pin 34c passes through the third slit 36c.

As shown in FIG. 11A, when the lever connector 3 is inserted by a predetermined amount into the accommodating portion 5, the third cam pin 34c of the mating connector 4 abuts against and presses the elastic piece 40 of the lever 2, so that the elastic piece 40 is disengaged from the groove portion 41 of the connector housing 7. Thus, the fitting direction rotation restricting mechanism 39 is released, so that the lever 2 is allowed to be operated to rotate along an arc. Therefore, the lever 2 located at the initial position can be rotated along an arc toward the fitting position as shown in FIG. 11B.

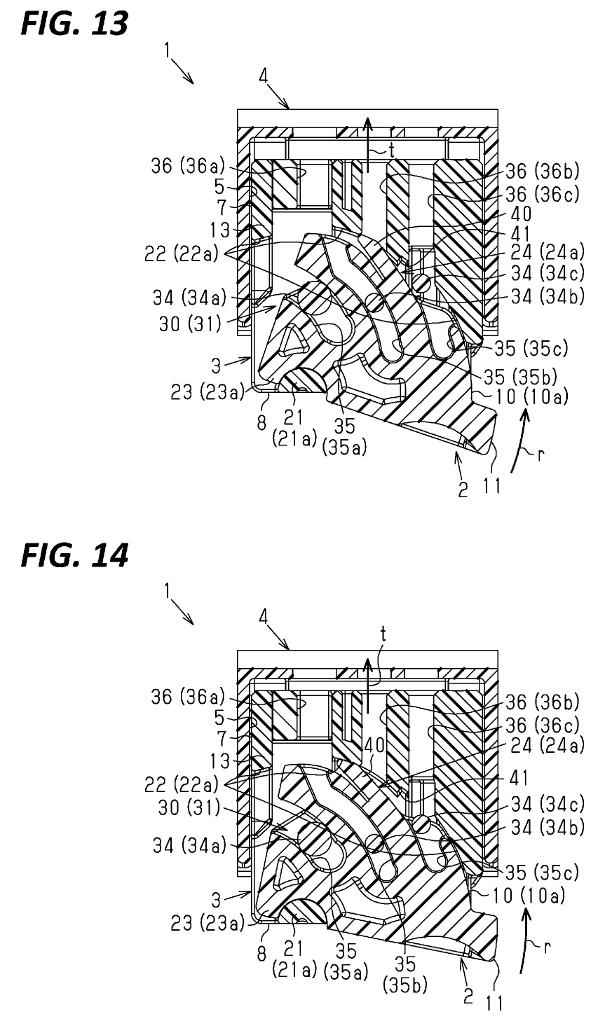

As shown in FIG. 13, when an operation load is applied to the lever 2 after the fitting direction rotation restricting mechanism 39 is released, the arm portion 10 of the lever 2 moves toward the fitting position by rotating along an arc between the inner sliding portion 21 and the outer sliding portion 22. In an initial stage of the lever operation, the first cam pin 34a slides in the first cam groove 35a, and the second cam pin 34b slides in the second cam groove 35b.

In the latter half of the lever operation, the third cam pin 34c enters the third cam groove 35c as shown in FIG. 14. That is to say, all of the cam pins 34 and the cam grooves 35 act when the lever comes close to an end position of the lever operation.

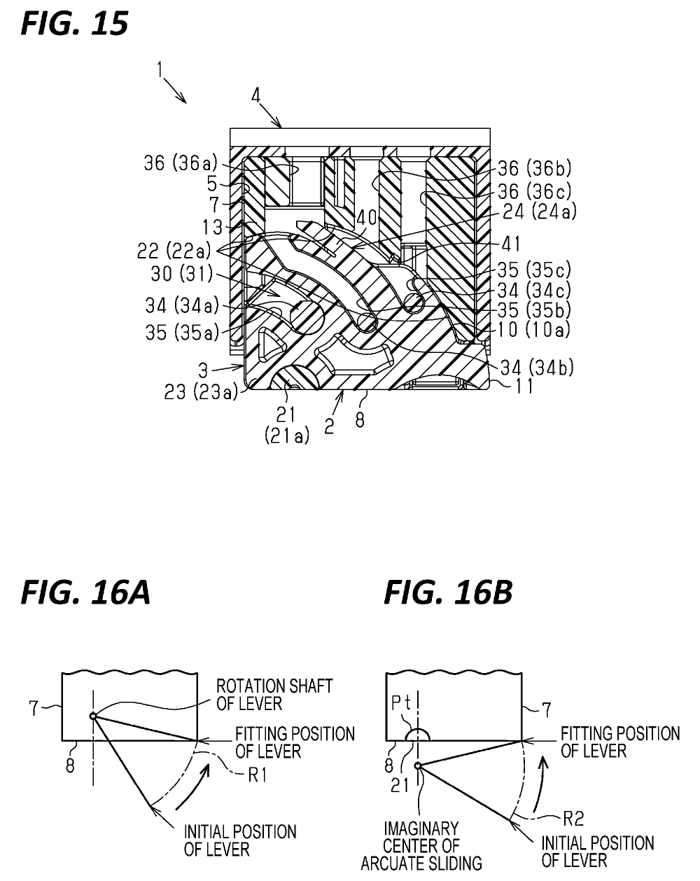

As shown in FIG. 15, when the cam pins 34 enter the deepest parts of the cam grooves 35, the lever 2 reaches the fitting position. When the lever 2 reaches the fitting position, the lever connector 3 is completely accommodated in the accommodating portion 5 of the mating connector 4. When the lever 2 reaches the fitting position, the back surface (rear end) of the arm portion 10 of the lever 2 extends parallel to the terminal insertion surface 8 of the connector housing 7. As described above, in the process of operating the lever 2 from the initial position to the fitting position, the connector housing 7 of the lever connector 3 is drawn into the mating connector 4 and the lever connector 3 is fitted to the mating connector 4.

### Advantages of Connector 1 of This Example

As shown in FIG. 7, etc., the structure for moving the lever 2 between the initial position and the fitting position causes the lever 2 to rotate along an arcuate locus. If the lever 2 is of a simple rotary operation type in which a rotation shaft of the connector housing 7 is fitted into a hole of the lever 2, the rotation shaft for rotating the lever 2 is necessary, and moreover, a region on the periphery of the rotation shaft needs to have a shape that exhibits sufficient strength, so that there is a limit to downsizing of the connector. On the other hand, the structure of this example causes the lever 2 to rotate along an arc, and therefore, the space required for disposing parts is smaller than that of the case where the lever 2 is of a rotary type and requires a rotation shaft. Therefore, the connector 1 can be downsized.

If the lever 2 is of a simple rotary operation type and has a double-supported shape, in order to engage the lever 2 having this shape with rotation shafts of the connector housing 7, it is necessary to engage the pair of arm portions 10 of the lever 2 with the rotation shafts while widening the space between the arm portions, so that the attaching operation requires effort. On the other hand, in this example, it is sufficient to form the hook-shaped lever inner circumferential portion 23 at the tip of each arm portion 10 of the lever 2 and to hook the hook-shaped lever inner circumferential portion 23 on the corresponding inner sliding portion 21 of the connector housing 7. Therefore, the lever 2 can be attached to the connector housing 7 with a simple operation.

Also, in the case where the lever 2 is of a simple rotary operation type and has a double-supported shape, if the space between the pair of arm portions 10 of the lever 2 is excessively widened to engage the lever 2 having this shape with the rotation shafts of the connector housing 7, the arm portions 10 may be damaged. On the other hand, in this example, it is sufficient to hook the hook-shaped lever inner circumferential portion 23 on the inner sliding portion 21 of the connector housing 7, and accordingly, it is unnecessary to widen the space between the pair of arm portions 10 when attaching the lever 2. Therefore, the lever 2 will not be damaged.

FIG. 16A is a diagram showing an outermost circumferential locus R1, which is the locus of an end (the operating portion 11) of a rotary type lever 2 when the lever is operated to rotate from the initial position to the fitting position. If the lever 2 is of a rotary type, the lever 2 has a rotation shaft at a deep position in the connector housing 7, and accordingly, when the lever 2 is located at the initial position, the lever 2 is in front of the terminal insertion surface 8 of the connector housing 7. Therefore, when terminals are to be attached to the terminal insertion holes 9 in the terminal insertion surface 8, the operating portion 11 of the lever 2 hinders the attachment work, making the efficiency of the terminal attachment work low.

FIG. 16B is a diagram showing an outermost circumferential locus R2, which is the locus of an end (the operating portion 11) of the lever 2 of this example when the lever operated to rotate along an arc rotates from the initial position to the fitting position. The lever 2 of this example is of an arcuate rotary operation type, and accordingly, an imaginary center of the rotation of the lever 2 is spaced apart from the terminal insertion surface 8 of the connector housing 7. Therefore, the outermost circumferential locus R2 is spaced apart from the terminal insertion surface 8. Accordingly, when the lever 2 is located at the initial position, the lever 2 is spaced apart from the terminal insertion surface 8 of the connector housing 7. Therefore, when terminals are to be inserted into the terminal insertion holes 9 in the terminal insertion surface 8, the operating portion 11 of the lever 2 does not hinder the insertion, and the efficiency of the terminal attachment work can be improved.

### Effects of Embodiment

With the connector 1 according to the above embodiment, the following effects can be obtained.

(1) The connector 1 includes the arcuate rotation mechanism 20 that rotates the lever 2 along an arcuate locus between the initial position and the fitting position and the conversion mechanism 30 that converts the operating direction of the lever 2 along an arc to the fitting direction in which the lever connector 3 is fitted to the mating connector 4 in conjunction with the movement of the lever 2 rotated along the arc by the arcuate rotation mechanism 20. The arcuate rotation mechanism 20 includes: the hook-shaped lever inner circumferential portion 23 formed at the tip of the lever 2; the inner sliding portion 21 that is formed in the connector housing 7 and is in sliding contact with the lever inner circumferential portion 23; the lever outer circumferential portion 24 formed on the surface of the lever 2 opposite to the lever inner circumferential portion 23; and the outer sliding portion 22 that is formed in the connector housing 7 and is in sliding contact with the lever outer circumferential portion 24.

According to this configuration, when the lever 2 is operated from the initial position to the fitting position, the lever connector 3 is fitted to the mating connector 4 due to the operating direction of the lever 2 being converted to the fitting direction of the lever connector 3 by the conversion mechanism 30. At this time, the lever 2 is rotated by the arcuate rotation mechanism 20 so as to follow an arcuate locus. As described above, in this example, the movement structure of the lever 2 is a rotary structure in which the lever 2 is operated to slide. Therefore, when compared with a case where the lever 2 is of a simple rotary operation type, for example, there is no need to provide a rotation shaft for the lever 2, so that the space required for disposing parts can be reduced. Accordingly, the connector 1 can be downsized.

(2) The connector housing 7 has the terminal insertion surface 8 having the terminal insertion holes 9 into which terminals are inserted. The inner sliding portion 21 is disposed on the same plane as the terminal insertion surface 8. With this configuration, an imaginary center of the locus of the lever 2 operated to rotate along an arc can be set apart from the terminal insertion surface 8 in the direction opposite to the fitting direction of the lever connector 3. Accordingly, the outermost circumferential locus R2 of the lever 2 when the lever 2 is rotated from the initial position to the fitting position can be set far from the connector housing 7. Therefore, the terminal insertion surface 8 is hardly hidden by the operating portion 11 of the lever 2, and the terminals can be easily inserted into the terminal insertion holes 9.

(3) When a direction along the longitudinal direction of the recess (in this example, the first recess 17 or the second recess 18) in the connector housing 7 into which the arm portion 10 of the lever 2 is inserted is defined as the prescribed direction Yk (e.g., the width direction of the connector housing 7), the inner sliding portion 21 is disposed at an end portion of the connector housing 7 in the prescribed direction Yk or in the vicinity of the end portion. According to this configuration, the inner sliding portion 21 is disposed at the end portion of the connector housing 7 in the prescribed direction Yk or in the vicinity of the end portion, and therefore, the arm portion 10 of the lever 2 can be made long. Therefore, a sufficient power assist effect of the lever 2 can be obtained. As a result, the operation load of the lever 2 can be reduced, thereby improving the efficiency of the fitting operation.

(4) The inner sliding portion 21 is in the form of a column with which the lever inner circumferential portion 23 of the lever 2 is engaged in a slidable manner, and opposite ends of the column are connected to the connector housing 7. In this configuration, the opposite ends of the columnar inner sliding portion 21 are supported by the connector housing 7, and therefore, the strength of the inner sliding portion 21 can be increased.

(5) The conversion mechanism 30 is the cam mechanism 31 that converts the operating direction of the lever 2 along an arc to the fitting direction in which the lever connector 3 is fitted to the mating connector 4 by the action of the cam structure including a cam pin 34 formed in the mating connector 4 and a cam groove 35 formed in the lever 2 to be engaged with the cam pin 34. The connector includes a plurality of pairs of the cam pin 34 and the cam groove 35. In this configuration, when the lever connector 3 is fitted to the mating connector 4 by operating the lever, the lever connector 3 can be supported by the plurality of cam pins 34 in a well-balanced manner. As a result, when the lever connector 3 is fitted to the mating connector 4, the lever connector 3 (the connector housing 7) is unlikely to tilt with respect to the mating connector 4. Therefore, the lever connector 3 can be smoothly fitted to the mating connector 4.

(6) When a line passing through the inner sliding portion 21 in the fitting direction of the lever connector 3 and the mating connector 4 is defined as the reference line Lk, the cam pins 34 are disposed on the side opposite to the end portion of the connector housing 7 in the prescribed direction Yk (e.g., the width direction of the connector housing 7) with respect to the reference line Lk. If the inner sliding portion 21 is disposed at or in the vicinity of the end portion of the connector housing 7 in the prescribed direction Yk, the space for disposing the cam mechanism 31 may be limited. However, in this configuration, the cam pins 34 are disposed in a space in which parts can be disposed. Therefore, it is possible to dispose the inner sliding portion 21 at or in the vicinity of the end portion of the connector housing 7 in the prescribed direction Yk and to secure the space for disposing the cam mechanism 31 at the same time.

### Other Embodiments

The present embodiment can be implemented with the following modifications. The present embodiment and the following modified examples can be implemented in combination with each other as long as there is no technical contradiction.

● There is no limitation to the configuration in which the inner sliding portion 21 is disposed at the end portion of the terminal insertion surface 8, and the inner sliding portion 21 may be disposed at a position other than the end portion.

● The number of pairs of the cam pin 34 and the cam groove 35 included in the cam mechanism 31 is not limited to two or more, and may be one.

● The cam mechanism 31 may be provided on only one of the pair of arm portions 10 of the lever 2 having the double-supported shape.

● The conversion mechanism 30 is not limited to the cam mechanism 31, and may be any mechanism that can convert the operating direction of the lever 2 to the fitting direction of the lever connector 3.

● In the reverse rotation restricting mechanism 38, the protrusion 38a may be formed on the lever 2 and the abutting wall 38b may be formed in the connector housing 7.

● In the lock mechanism 42, the lock arm 43 may be formed in the lever 2 and the protrusion 44 may be formed on the connector housing 7.

● The reverse rotation restricting mechanism 38, the fitting direction rotation restricting mechanism 39, and the lock mechanism 42 may be modified as appropriate to have structures or shapes other than those described in the above embodiment as long as they satisfy necessary functions.

● The lever 2 may have a cantilever structure, specifically a structure supported on one side.

● The connector 1 may have a structure in which a plurality of accommodating portions 5 are formed in the mating connector 4, and the lever connector 3 is fitted into each of the accommodating portions 5.

● The expression "at least one" as used in the present disclosure means "one or more" of desired options. By way of example, if there are two options, the expression "at least one" as used in the present disclosure means "only one option" or "both of the two options". As another example, if there are three or more options, the expression "at least one" as used in the present disclosure means "only one option" or "a combination of two or more given options".

● Although the present disclosure has been described according to an embodiment, it is to be understood that the present disclosure is not limited to the described embodiment and structures. The present disclosure also encompasses various variations and alterations within the range of equivalence. In addition, various combinations and forms as well as other combinations and forms that include one or more elements or from which one or more elements are omitted fall within the scope and idea of the present disclosure.

Next, technical ideas that can be grasped from the above-described embodiment and modified examples will be described.

(1) A lever connector including a connector housing that is drawn into a mating connector and fitted to the mating connector in a process of operating a lever from an initial position to a fitting position, the lever being provided in an operable manner on the connector housing, the lever connector including: an arcuate rotation mechanism that rotates the lever along an arcuate locus between the initial position and the fitting position; and a cam groove that converts an operating direction of the lever along an arc to a fitting direction in which the lever connector is fitted to the mating connector by allowing a cam pin provided in the mating connector to slide in the cam groove in conjunction with movement of the lever rotated along the arc by the arcuate rotation mechanism, wherein the arcuate rotation mechanism includes: a hook-shaped lever inner circumferential portion formed at a tip of the lever; an inner sliding portion that is formed in the connector housing and is in sliding contact with the lever inner circumferential portion; a lever outer circumferential portion formed on a surface of the lever opposite to the lever inner circumferential portion; and an outer sliding portion that is formed in the connector housing and is in sliding contact with the lever outer circumferential portion.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising a lever connector and a mating connector and configured such that a connector housing of the lever connector is drawn into the mating connector and fitted to the mating connector in a process of operating a lever from an initial position to a fitting position, the lever being provided in an operable manner on the lever connector configured to be connected to the mating connector, the connector further comprising:
an arcuate rotation mechanism that rotates the lever along an arcuate locus between the initial position and the fitting position; and
a conversion mechanism that converts an operating direction of the lever along an arc to a fitting direction in which the lever connector is fitted to the mating connector in conjunction with movement of the lever rotated along the arc by the arcuate rotation mechanism,
wherein the arcuate rotation mechanism includes:
a hook-shaped lever inner circumferential portion formed at a tip of the lever;
an inner sliding portion that is formed in the connector housing and is in sliding contact with the lever inner circumferential portion;
a lever outer circumferential portion that is formed on a surface of the lever opposite to the lever inner circumferential portion; and
an outer sliding portion that is formed in the connector housing and is in sliding contact with the lever outer circumferential portion.

2. The connector according to claim 1,
wherein the connector housing has a terminal insertion surface that has a terminal insertion hole into which a terminal is inserted, and
the inner sliding portion is disposed on the same plane as the terminal insertion surface.

3. The connector according to claim 1,
wherein, when a direction along a longitudinal direction of a recess in the connector housing into which an arm portion of the lever is inserted is defined as a prescribed direction, the inner sliding portion is disposed at an end portion of the connector housing in the prescribed direction or in a vicinity of the end portion.

4. The connector according to claim 1,
wherein the inner sliding portion is in the form of a column with which the lever inner circumferential portion of the lever is engaged in a slidable manner, and opposite ends of the column are connected to the connector housing.

5. The connector according to claim 1,
wherein the conversion mechanism is a cam mechanism that converts the operating direction of the lever along an arc to the fitting direction in which the lever connector is fitted to the mating connector by an action of a cam structure including a cam pin formed in the mating connector and a cam groove formed in the lever to be engaged with the cam pin, and
the connector includes a plurality of pairs of the cam pin and the cam groove.

6. The connector according to claim 3,
wherein the conversion mechanism is a cam mechanism that converts the operating direction of the lever along an arc to the fitting direction in which the lever connector is fitted to the mating connector by an action of a cam structure including a cam pin formed in the mating connector and a cam groove formed in the lever to be engaged with the cam pin, and
when a line passing through the inner sliding portion in the fitting direction of the lever connector and the mating connector is defined as a reference line, the cam pin is disposed on a side opposite to the end portion with respect to the reference line.
